(19) United States
(12) Patent Application Publication
(10) Pub. No.: US 2003/0034930 A1
(43) Pub. Date: Feb. 20, 2003

(54) Side-mounting waveguide

(75) Inventor: Mao-Jen Chen, Chung-Li City (TW)

Correspondence Address: DOUGHERTY & TROXELL, Suite 1404, 5205 Leesburg Pike, Falls Church, VA, 22041, US

(73) Assignee: Prime Electronics & Statellitcs Inc.

(21) Appl. No.: 09/928,416

(22) Filed: Aug. 14, 2001

(51) Int. Cl. H01Q 13/00

(52) U.S. Cl. 343/786; 343/776

(57) ABSTRACT

A side-mounting waveguide including a satellite down converter and a receiving horn antenna connected to the satellite down converter is characterized in that a circuit board of the satellite down converter is located at one side of the receiving horn antenna such that a transverse plane of the circuit board is in parallel with a direction in which the receiving horn antenna extends, and that a plastic rod is plugged into an opening of the receiving horn antenna to provide enhanced wave converging ability. With the side-mounting waveguide, the spacing between two adjacent satellite down converters and accordingly two adjacent receiving horn antennas is effectively reduced to correspond to the reduced angle contained between two satellites.

### FIELD OF THE INVENTION

The present invention relates to a side-mounting waveguide, and more particularly to a side-mounting waveguide adapted to reduce spacing between two adjacent satellite down converters and accordingly enhance the signal receiving ability of the satellite down converter.

### BACKGROUND OF THE INVENTION

The number of satellites in the outer space quickly increases with the prosperous development in the communication industry. In the past, satellite down converters aimed at the satellite group in the outer space may be spaced from one another at a wide distance corresponding to an angle of about 9 to 11 degrees contained between two adjacent satellites in the outer space. However, the angle contained between two adjacent satellites reduces to about 2 to 3 degrees with the increasing number of satellites in the outer space. Thus, it is necessary to arrange the satellite down converters more closely to correspond to the reduced angle contained between two adjacent satellites.

As shown in FIG. 1, multiple conventional satellite down converters 11 are arranged in a disk-shaped structure 10. Each satellite down converter 11 has a receiving horn antenna 12 connected thereto. Due to a width of each receiving horn antenna 12, the conventional satellite down converters 11 arranged in the disk-shaped structure must be spaced from one another by a sufficiently large distance. The wide space between two adjacent satellite down converters would result in big error in receiving signals transmitted from corresponding satellites in the outer space. Up to date, there is not any solution to such problems.

FIGS. 2 and 3 are sectioned side view and perspective view, respectively, of a conventional satellite down converter 11. As shown, the receiving horn antenna 12 and a circuit board 13 of the satellite down converter 11 are so arranged that the circuit board 13 is located behind the receiving horn antenna 12 with a transverse plane of the circuit board 13 being perpendicular to a direction in which the receiving horn antenna 12 extends. Due to the circuit board 13 and a case of the down converter 11, there is a large spacing between two adjacent receiving horn antennas 12. This large spacing prevents the conventional satellite down converters 11 from effectively corresponding to the reduced angle of 2 to 3 degrees currently contained between two adjacent satellites to meet requirements in nowaday satellite communication.

It is therefore tried by the inventor to develop a side-mounting waveguide that is capable of reducing the spacing between two adjacent satellite down converters and enhancing the signal receiving ability of the satellite down converter.

### SUMMARY OF THE INVENTION

A primary object of the present invention is to provide a side-mounting waveguide including a satellite down converter and a receiving horn antenna connected to the satellite down converter. The side-mounting waveguide is characterized in that a circuit board of the satellite down converter is located at one side of the receiving horn antenna such that a transverse plane of the circuit board is in parallel with a direction in which the receiving horn antenna extends. That is, the manner of feeding signal is changed. Thus, the spacing between two adjacent satellite down converters and accordingly two adjacent receiving horn antennas is effectively reduced to correspond to the reduced angle contained between two satellites.

And, to enhance the signal receiving ability of the receiving horn antenna, a wave-converging plastic rod is plugged into an opening of the horn antenna. dr

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing the manner in which satellite down converters are arranged in a disk-shaped structure;

FIG. 2 is a sectioned side view showing the structure of a conventional satellite down converter;

FIG. 3 is a perspective view showing the manner in which two conventional satellite down converters are arranged;

FIG. 4 is a sectioned side view showing the structure of a satellite down converter according to the present invention; and

FIG. 5 is a perspective view showing the manner in which two satellite down converters of the present invention are arranged.

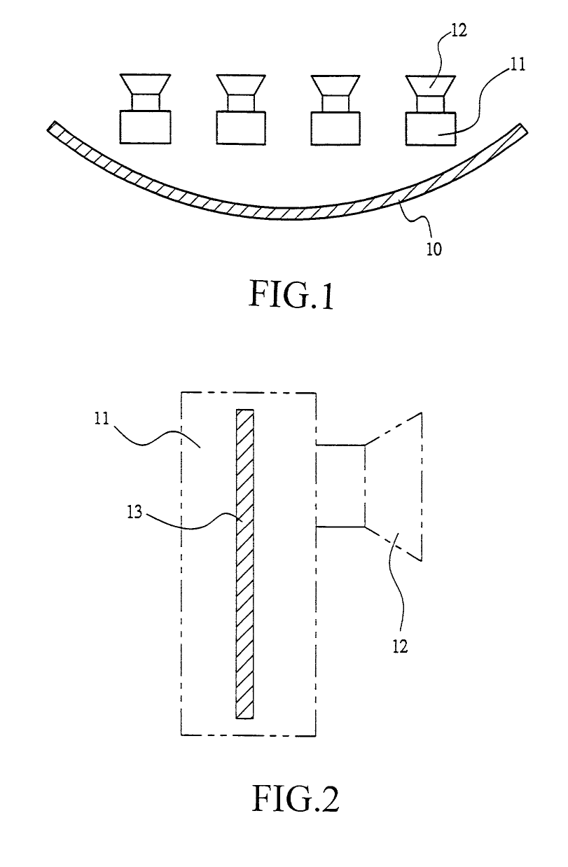

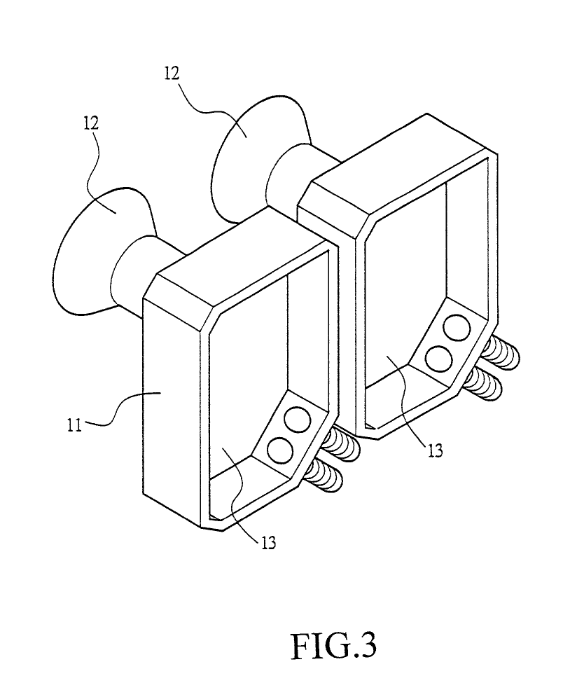

### DETAILED DESCRIPTION OF THE PREFERRED EMBODIMENTS

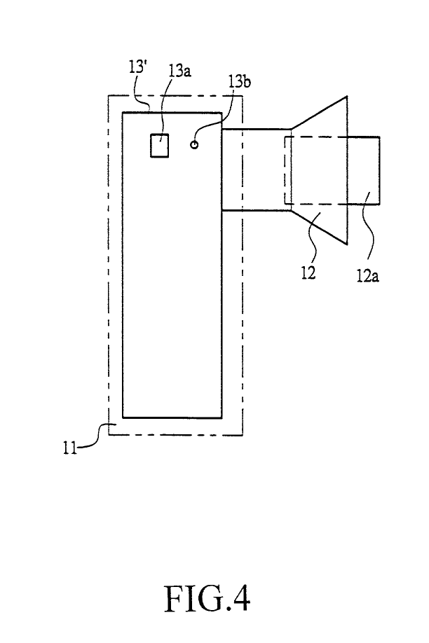

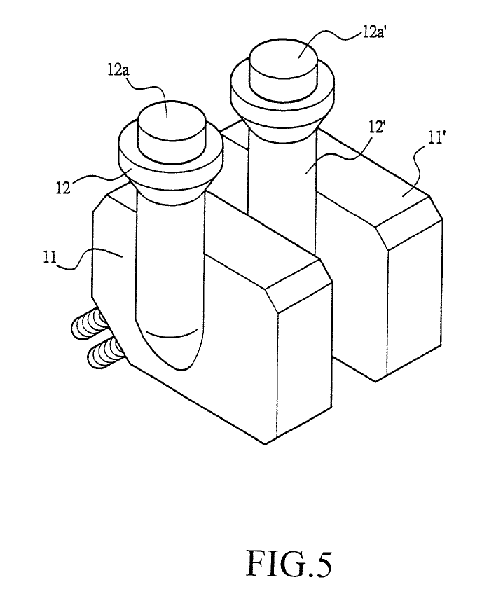

Please refer to FIG. 4 that is a sectioned side view showing the structure of a side-mounting waveguide according to the present invention, and to FIG. 5 that is a perspective view showing the manner in which two satellite down converters using the side-mounting waveguide of the present invention are arranged.

As shown in FIGS. 4 and 5, the side-mounting waveguide of the present invention includes a receiving horn antenna 12 and a circuit board 13′ for the satellite down converter 11. The receiving horn antenna 12 and the circuit board 13′ are so arranged that the circuit board 13′ is not located behind but at one side of the receiving horn antenna 12 with a transverse plane of the circuit board 13′ being parallel to a direction in which the receiving horn antenna 12 extends. In response to this change in the position of the circuit board, a direction for feeding signal must be changed at the same time and such change necessitates some inventive measures. In the present invention, the necessary inventive measures taken to change the direction for feeding signal include adding of a square waveguide 13a and a probe 13b to the circuit board 13′. Meanwhile, a wave-converging plastic rod 12a is plugged into an opening of the receiving horn antenna 12 to enhance the signal receiving ability of the satellite down converter 11. The plastic rod 12a is made of polyethylene material that has small wave attenuation and big dielectric constant and is therefore operative to converge waves.

It is understood that the mounting of any wave-guiding element made of other material in an attempt to enhance the signal receiving ability is a modification that can be easily derived from the present invention and therefore should be included in the scope of the present invention.

FIG. 5 shows the manner of arranging two or more units of side-mounting waveguide of the present invention. As shown, the waveguides are arranged side by side with each circuit board 13′ of the satellite down converter 11 located between two adjacent receiving horn antennas 12. In this manner, the spacing between two adjacent satellite down converters 11 and accordingly two adjacent antennas 12 is effectively reduced to satisfactorily correspond to a small angle of less than 2 degrees possibly contained between two adjacent satellites. The present invention is therefore adapted for use even in a future condition in which the angle contained between two adjacent satellites is further reduced. Thus, the present invention is highly useful in the communication industry.

In conclusion, the present invention provides a side-mounting waveguide that includes a circuit board 13′ located at one side of the receiving horn antenna 12 in parallel with the latter, enabling an effectively reduced spacing between any two adjacent satellite down converters for the same to be used in a future condition in which the angle contained between two adjacent satellites is less than 2 degrees. Moreover, the receiving horn antenna 12 in the side-mounting waveguide of the present invention is provided at the opening thereof with a wave-converging plastic rod 12a to enhance the signal receiving ability of the satellite down converter.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A side-mounting waveguide comprising a satellite down converter and a receiving horn antenna connected to said satellite down converter, said side-mounting waveguide being characterized in that a circuit board of said satellite down converter is located at one side of said receiving horn antenna, such that a transverse plane of said circuit board is in parallel with a direction in which said receiving horn antenna extends.

2. The side-mounting waveguide as claimed in claim 1, wherein said receiving horn antenna includes a wave-converging plastic rod plugged into an opening of said horn antenna.
